(19) United States
(12) Patent Application Publication
(10) Pub. No.: US 2026/0358546 A1
(43) Pub. Date: Nov. 12, 2026

(54) OPTICAL FILM STRUCTURE, BACKLIGHT MODULE AND DISPLAY DEVICE

(71) Applicant: Radiant Opto-Electronics Corporation, Kaohsiung City (TW)

(72) Inventors: Wei-Hsuan CHEN, Kaohsiung City (TW); Yung-Hui TAI, Kaohsiung City (TW); Chung-Yung TAI, Kaohsiung City (TW); Kai-Hsiang LIU, Kaohsiung City (TW)

(21) Appl. No.: 19/651,833

(22) Filed: Apr. 20, 2026

(30) Foreign Application Priority Data
May 9, 2025 (CN) 202520906619.2

(51) Int. Cl. F21V 8/00; G02F 1/1335; G02F 1/13357

(52) U.S. Cl. CPC G02B 6/0036; G02B 6/0091; G02F 1/133607; G02F 1/133615

(57) ABSTRACT

An optical film structure has a first surface and a second surface opposite to each other and includes multiple first prisms and multiple second prisms. The first prisms are located at the first surface, and each first prism extends in a first direction. The second prisms are located at the second surface, and each second prism extends in a second direction different from the first direction. The second prisms have an arrangement density y, and each second prism has a first inclined surface and a second inclined surface connected to each other. An included angle x is formed between the first inclined surface and the second inclined surface. The arrangement density y and the included angle x satisfy a first density mathematical formula: 0<y≤−0.00000543x³+0.00193x²−0.20997x+7.46116.

### CROSS-REFERENCE TO RELATED APPLICATION

This application claims priority to Chinese Patent Application No. 202520906619.2, filed May 9, 2025, which is herein incorporated by reference in its entirety.

### BACKGROUND

### Field of Invention

The present disclosure relates to an optical film structure, a backlight module including the aforementioned optical film structure, and a display device including the aforementioned backlight module.

### Description of Related Art

TCO Certified is a display certification standard established by the Swedish Federation of Professional Employees. It sets standards for human health and the environment, directly addressing the impact of display devices on user health. For example, to enhance user comfort and reduce fatigue, TCO Certified has certain requirements for the ergonomic characteristics of display devices, such as the luminance of the display device at different viewing angles.

Currently, the optical films used in backlight modules are mainly used to concentrate light in the direction of the front viewing angle. However, most of the brightness enhancement films available on the market today can only concentrate light in a single direction. To simultaneously enhance brightness in another direction, it is necessary to stack another brightness enhancement film with a different directionality. The aforementioned stacking method not only increases manufacturing costs and complexity, but also has the following significant drawbacks:

Limited viewing angles: While traditional brightness enhancement films can enhance brightness, they often result in narrower viewing angles; when viewed from an angle other than the front viewing angle, the brightness and color performance of the image will significantly deteriorate.

Additional layers of film increases thickness and cost: The design of double-layer brightness enhancement film inevitably increases the overall thickness and manufacturing cost of the display device, which is not conducive to the trend of thinner and lighter design.

Therefore, one of the goals that those skilled in the art aim to achieve is the development of an optical film structure that can meet luminance uniformity specifications at different viewing angles when applied to display devices, while also enhancing contrast within the normal viewing angle range.

### SUMMARY

At least one embodiment of the present disclosure provides an optical film structure, a backlight module including the aforementioned optical film structure, and a display device including the aforementioned backlight module that can enable the display device to meet luminance uniformity specifications at different viewing angles and enhance contrast within the normal viewing angle range through the design of the arrangement density and the included angle of the prisms in the optical film structure.

The optical film structure according to at least one embodiment of the present disclosure has a first surface and a second surface opposite to the first surface, and includes multiple first prisms and multiple second prisms. The first prisms are located at the first surface, and each of the first prisms extends in a first direction. The second prisms are located at the second surface, and each of the second prisms extends in a second direction different from the first direction. The second prisms have an arrangement density y. Each of the second prism has a first inclined surface and a second inclined surface connected to each other, and an included angle x is formed between the first inclined surface and the second inclined surface. The arrangement density y and the included angle x satisfy a first density mathematical formula: 0<y≤−0.00000543x³+0.00193x²−0.20997x+7.46116.

The backlight module according to at least one embodiment of the present disclosure includes a light guide plate, a light source and the aforementioned optical film structure. The light guide plate has a light-incident surface and a light-emitting surface, the light source is disposed at the light-incident surface, and the aforementioned optical film structure is disposed in front of the light-emitting surface.

The backlight module according to at least another embodiment of the present disclosure includes a light source and the aforementioned optical film structure. The light source includes a substrate and multiple light-emitting units arranged on the substrate, and the aforementioned optical film structure is disposed in front of the light source.

The display device according to at least one embodiment of the present disclosure includes the aforementioned backlight module and a display panel disposed in front of the backlight module.

### BRIEF DESCRIPTION OF THE DRAWINGS

FIG. 1 is a schematic cross-sectional view of an optical film structure according to at least one embodiment of the present disclosure.

FIG. 2 is a curve diagram of a first density mathematical formula according to at least one embodiment of the present disclosure.

FIG. 3 is a schematic enlarged view of region A in FIG. 1.

FIG. 4 and FIG. 5 are curve diagrams illustrating the relationship between horizontal viewing angle and relative brightness simulated by using the optical film structure of at least one embodiment of the present disclosure and the optical film structure of a comparative example.

FIG. 6 is a curve diagram of a first density mathematical formula, a second density mathematical formula and a third density mathematical formula according to at least one embodiment of the present disclosure.

FIG. 7 is a curve diagram illustrating the relationship between horizontal viewing angle and relative brightness simulated by using the optical film structure of at least one embodiment of the present disclosure and the optical film structure of a comparative example.

FIG. 8A to FIG. 8C are schematic diagrams showing the light output intensity at various viewing angles simulated by using the optical film structure of at least one embodiment of the present disclosure.

FIG. 9A and FIG. 9B are schematic views of a display device using an optical film structure according to at least one embodiment of the present disclosure.

FIG. 10 is a schematic cross-sectional view of an optical film structure according to at least another embodiment of the present disclosure.

FIG. 11 is a schematic cross-sectional view of a backlight module according to at least one embodiment of the present disclosure.

FIG. 12 is a schematic cross-sectional view of a backlight module according to at least another embodiment of the present disclosure.

FIG. 13 is a schematic cross-sectional view of a display device according to at least one embodiment of the present disclosure.

### DETAILED DESCRIPTION

In the following description, in order to clearly present the technical features of the present disclosure, the dimensions of elements in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances.

Furthermore, the words “about”, “approximately” or “substantially” used in the present disclosure not only cover the clearly stated numerical values and numerical ranges, but also cover those that can be understood by a person with ordinary knowledge in the technical field to which the present disclosure belongs. The permissible deviation range can be determined by the error generated during measurement, and the error is caused, for example, by limitations of the measurement system or process conditions. For example, two objects (such as the plane or traces of a base) are “substantially parallel” or “substantially perpendicular”, where “substantially parallel” and “substantially perpendicular” mean that parallelism and perpendicularity, respectively, between the two objects can include non-parallelism and non-perpendicularity caused by permissible deviation ranges.

In addition, “about” may mean within one or more standard deviations of the above values, such as within ±30%, ±20%, ±10%, or ±5%. Such words as “about”, “approximately”, or “substantially” as appearing in the present disclosure may be used to select an acceptable range of deviation or standard deviation according to optical properties, etching properties, mechanical properties, or other properties, rather than applying all of the above optical properties, etching properties, mechanical properties, and other properties with a single standard deviation.

The spatial relative terms used in the present disclosure, such as “below,” “under,” “above,” “on,” and the like, are intended to facilitate the recitation of a relative relationship between one element or feature and another as depicted in the drawings. The true meaning of these spatial relative terms includes other orientations. For example, the relationship between one element and another may change from “below” and “under” to “above” and “on” when the drawing is turned 180 degrees up or down. In addition, spatially relative descriptions used in the present disclosure should be interpreted in the same manner.

It should be understood that while the present disclosure may use terms such as “first”, “second”, “third” to describe various elements or features, these elements or features should not be limited by these terms. These terms are primarily used to distinguish one element from another or one feature from another. In addition, the term “or” as used in the present disclosure may include, as appropriate, any one or a combination of the listed items in association.

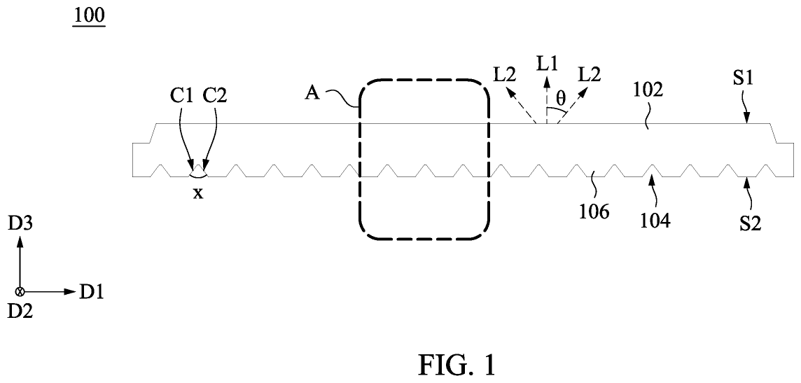

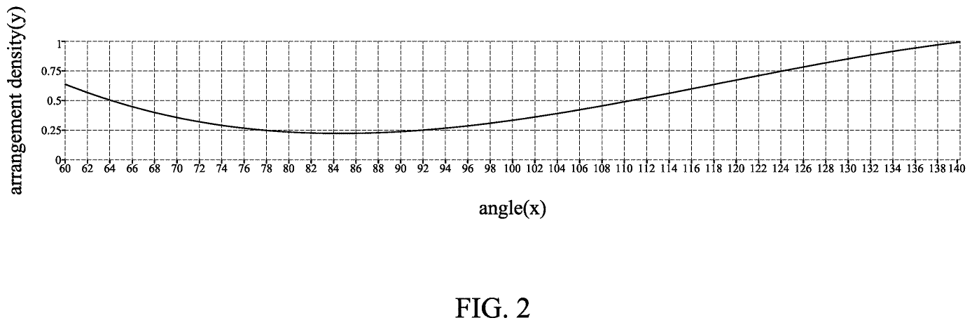

Referring to FIG. 1 and FIG. 2, the optical film structure 100 has a first surface S1 and a second surface S2 opposite to the first surface S1, and includes multiple first prisms 102 and multiple second prisms 104. The first prisms 102 are located at the first surface S1, and each of the first prisms 102 extends in a first direction D1. The second prisms 104 are located at the second surface S2, and each of the second prisms 104 extends in a second direction D2 different from the first direction D1. In this way, when light enters the optical film structure 100 from one of the first surface S1 and the second surface S2, the second prisms 104 can turn a portion of the straight light into the light in other directions, so that the light in other directions can exit from the other of the first surface S1 and the second surface S2.

In detail, as shown in FIG. 1, when light enters the optical film structure 100, a portion of the light (e.g., the light L1) can directly pass through the blank area between adjacent second prisms 104 and then the light L1 emits in the frontal viewing direction to produce frontal viewing luminance, and a portion of the light (e.g., the light L2) can be turned by the second prisms 104 and then the light L2 emits in the side viewing direction to produce side viewing luminance. The frontal viewing direction referred to here is the direction parallel to the normal of the optical film structure 100 (i.e., the third direction D3), and an angle θ is between the side viewing direction and the frontal viewing direction.

The second prisms 104 have an arrangement density y, and each of the second prisms 104 has a first inclined plane C1 and a second inclined plane C2 connected to each other. An included angle x is formed between the first inclined plane C1 and the second inclined plane C2, and the arrangement density y and the included angle x satisfy a first density mathematical formula: 0<y≤−0.00000543x³+0.00193x²−0.20997x+7.46116. By adjusting the arrangement density y and the included angle x of the second prisms 104, and setting the value of y to be less than the value obtained by polynomial calculation of x, the ratio of light emitted in the frontal viewing direction and the light emitted in the side viewing direction can be further controlled to maintain the frontal viewing luminance and reduce light leakage at large viewing angles, and thus improving the display quality. In short, the present disclosure mainly addresses the issue of light leakage at large viewing angles, where light is still visible from a side view even when the image is darkened, resulting in poor contrast. Therefore, reducing light leakage at large viewing angles can maintain high contrast.

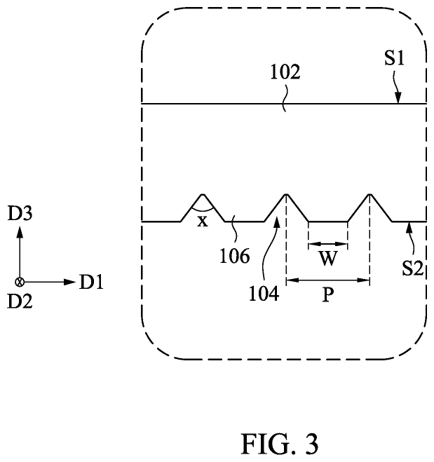

Referring to FIG. 3, an interval 106 exists between any adjacent two of the second prisms 104, and the aforementioned arrangement density y is obtained by calculation via a function:

$$y = \frac{( P - W )}{P} ,$$

where P is the pitch between any adjacent two of the second prisms 104, and W is the width of each interval 106. The function allows for precise control of the arrangement density of the second prisms 104, thereby achieving better optical performance.

In this embodiment, each of the second prisms 104 includes a strip-shaped groove, that is, a strip-shaped structure recessed in the direction from the second surface S2 to the first surface S1. In other embodiments, each of the second prisms 104 may include a strip-shaped rib, that is, a strip-shaped structure protruding in the direction from the first surface S1 to the second surface S2. The strip-shaped structure is simple and easy to manufacture, which can reduce production costs. In addition, it is important to note that when the second prisms 104 are located at the light-incident side, both inwardly recessed structures and outwardly protruding structures can achieve the light-dispersing effect; when the second prisms 104 are located at the light-emitting side, the second prisms 104 must be inwardly recessed structures to achieve the light-dispersing effect. If the second prisms 104 are located at the light-emitting side and designed as outwardly protruding structures, the second prisms 104 will produce the light-concentrating effect, which is not conducive to dispersing the light from the frontal viewing direction to a slightly tilted viewing direction, resulting in poor viewing angle uniformity.

In some embodiments, the first direction D1 is substantially perpendicular to the second direction D2, and the first direction D1 and the second direction D2 are substantially perpendicular to the third direction D3. The vertical arrangement not only effectively concentrates light in a single direction, but also allows for precise control of light in another direction, effectively dispersing light from the frontal viewing direction to a slightly tilted viewing direction, thus improving the viewing angle uniformity.

Furthermore, this embodiment adopts a single-layer optical film structure, which effectively simplifies the manufacturing process, reduces costs, and facilitates the thinner and lighter design of the display device.

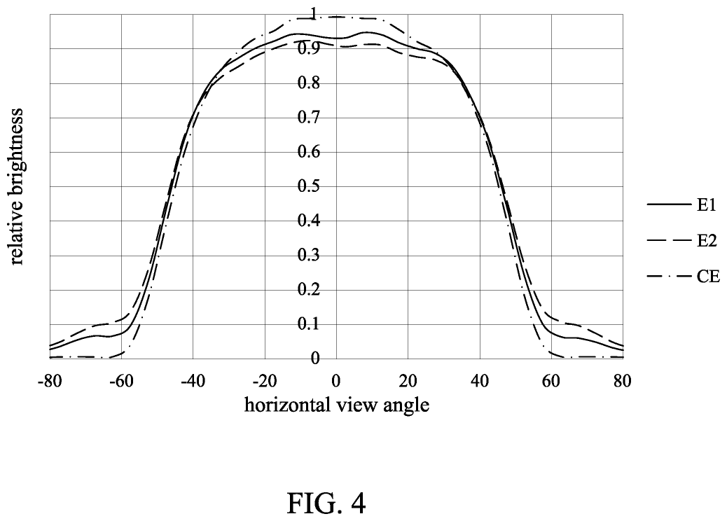

Referring to FIG. 4, Embodiment 1 is an optical film structure with an included angle x of 90 degrees and an arrangement density y of 5% that satisfies the first density mathematical formula, Embodiment 2 is an optical film structure with an included angle x of 90 degrees and an arrangement density y of 10% that satisfies the first density mathematical formula, and the comparative example is an optical film that only has prisms that concentrates light to emit in frontal viewing direction but free of the above-mentioned second prisms 104. The relative brightness is the result of luminance normalization at 0 degrees for the comparative example, Embodiment 1, and Embodiment 2, as shown in FIG. 4, the comparative example, lacking the above-mentioned second prisms 104, cannot emit light in the side viewing direction after being turned by the second prism 104, thus failing to produce side viewing luminance.

The comparative example can only emit light in the frontal viewing direction directly through the blank area, so the relative brightness at 0 degrees (i.e., the frontal viewing direction) is approximately 1, decreases to approximately 0.95 at 20 degrees, and further decreases to approximately 0.69 at ±40 degrees. The relative brightness of Embodiment 1 and Embodiment 2 at 0 degrees are approximately 0.93 and 0.91, respectively. The relative brightness decreases to approximately 0.91 and 0.89 at ±20 degrees, respectively, and decreases to approximately 0.7 at ±40 degrees.

Since the maximum value of the arrangement density y satisfying the first density mathematical formula is 23.84% as the included angle x of the second prisms 104 is 90 degrees, when the arrangement densities y are respectively 5% and 10% and satisfy the first density mathematical formula, after light enters the optical film structure 100, the second prisms 104 can turn a portion of the light that originally emitted at 0 degrees to the light emitted in other larger viewing angles. Therefore, as can be seen from the relative brightness between 0 degrees and ±40 degrees in Embodiment 1 and Embodiment 2, although the relative brightness at 0 degrees is relatively low, and decreases by 2% at ±20 degrees compared to 0 degrees; however, at ±40 degrees, the relative brightness decreases by 21% and 19% compared to ±20 degrees, resulting in a gradual decline in brightness at larger viewing angles. Compared to the relative brightness between 0° and ±40° in the comparative example, the relative brightness at 0° degrees is relatively high, and the relative brightness decreases by 5% at ±20 degrees compared to 0 degrees and decreases by 26% at ±40 degrees compared to ±20 degrees, indicating a steep decline in brightness at larger viewing angles. That is, when the arrangement density y and the included angle x of the second prisms 104 in the optical film structure 100 satisfy the design of the first density mathematical formula, the decline in brightness at larger viewing angles is gradual, thereby improving the luminance uniformity of the display device at different viewing angles and meeting the requirement of 5.10 luminance uniformity—angular dependence in TCO Certified—Generation 9 for displays.

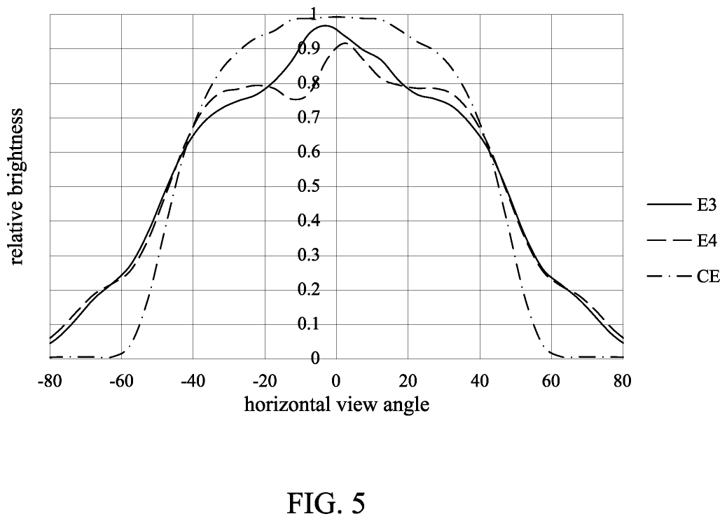

Referring to FIG. 5, Embodiment 3 is an optical film structure with an included angle x of 130 degrees and an arrangement density y of 50% that satisfies the first density mathematical formula, Embodiment 4 is an optical film structure with an included angle x of 120 degrees and an arrangement density y of 50% that satisfies the first density mathematical formula, and the comparative example is an optical film that only has prisms that concentrates light to emit in frontal viewing direction but free of the above-mentioned second prisms 104. The relative brightness is the result of luminance normalization at 0 degrees for the comparative example, Embodiment 3, and Embodiment 4, as shown in FIG. 5, the comparative example has the relative brightness of approximately 1 at 0 degrees (i.e., in the frontal viewing direction), which decreases to approximately 0.95 at ±20 degrees and to approximately 0.02 at 60 degrees. The relative brightness of Embodiment 3 and Embodiment 4 is approximately 0.96 and 0.91 at 0 degrees, respectively, and the relative brightness decreases to approximately 0.78 and 0.79 at ±20 degrees and to approximately 0.25 at ±60 degrees.

Since the included angles x of the second prism 104 are 120 degrees and 130 degrees respectively, when the included angles x increase from 90 degrees to 120 degrees and 130 degrees, the maximum value of the arrangement density y that satisfies the first density mathematical formula can also increase to 67.37% and 85.24%. Therefore, when the arrangement density y is 50% and satisfies the first density mathematical formula, after light enters the optical film structure 100, the second prisms 104 can turn a portion of the light, including but not limited to that originally emitted at ±40 degrees and ±20 degrees, to the light emitted within ±10 degrees. Therefore, compared to the comparative example, Embodiment 3 and Embodiment 4 can enhance the brightness within ±10 degrees, improve brightness and contrast near the front viewing angle, and maintain brightness within ±40 degrees, thereby meeting the requirement of 5.10 luminance uniformity—angular dependence in TCO Certified—Generation 9 for displays.

In addition, it should be noted that although the brightness of Embodiment 1 to Embodiment 4 is relatively low at the 0-degree viewing angle, in order to compensate for this issue, a material with a high refractive index (n≥1.59) can be used to make the first prisms 102. Moreover, the higher the refractive index, the greater the concentration of emitted light, which is concentrated towards the 0-degree viewing angle, the brightness at the front viewing angle can be effectively improved.

Furthermore, after light enters the optical film structure 100, the second prisms 104 can turn a portion of the light, including but not limited to that originally emitted at ±25 degrees and ±15 degrees, to the light emitted at degrees greater than ±60 degrees. Therefore, when the included angle x is set between 120 and 130 degrees, the light within ±20 degrees can be effectively suppressed. Specifically, in Embodiment 4, the included angle x of 120 degrees suppresses the light within approximately ±25 degrees. In Embodiment 3, the included angle x of 130 degrees suppresses the light within approximately ±15 degrees. The suppressed light is actually turned and emitted at larger viewing angles, such as approximately ±60 degrees or even ±80 degrees. As a result, Embodiment 3 and Embodiment 4 can enhance the brightness near 0 degrees compared to the comparative example, thereby improving the brightness and contrast near the front viewing angle.

For gaming monitors, slight light leakage may occur in the LCD panel at larger viewing angles, resulting in insufficient black levels. To improve this issue, this embodiment reduces or suppresses the brightness around the viewing angle of approximately 20 degrees, and the chance of viewing the display device from angles greater than ±60 degrees is very low. Therefore, even if the light is turned to angles greater ±60 degrees, viewers of gaming monitors typically do not view the screen from such large angles (e.g., 60 or 80 degrees), so it is unlikely to significantly affect the actual viewing experience or display quality.

In other words, the arrangement density y and the included angle x of the second prisms 104 of the optical film structure 100 satisfy the design of the first density mathematical formula, which can improve the contrast of the display device in the normal viewing angle range.

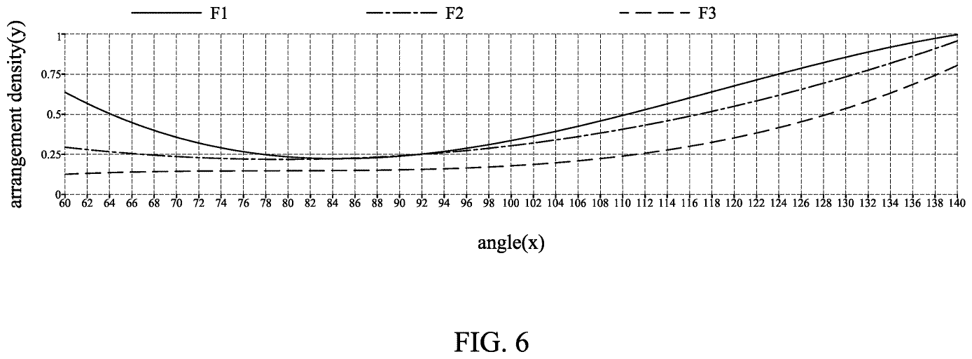

Referring to FIG. 6, the arrangement density y and the included angle x of the second prisms 104 can further satisfy the second density mathematical formula and the third density mathematical formula, the second density mathematical formula is 0<y≤0.0002x²−0.0318x±1.4829, and the third density mathematical formula is 0<y≤0.00000277x³−0.000654x²±0.05165x−1.21674. As shown in FIG. 6, as the conditions of the first density mathematical formula, the second density mathematical formula and the third density mathematical formula are satisfied, the value of the arrangement density y decreases. In other words, when the highest arrangement density is required, the first density mathematical formula is used, which provides better luminance uniformity at the viewing angle. Conversely, when the lowest arrangement density is required, the third density mathematical formula is used, the luminance uniformity at different viewing angles is decreased, but the higher brightness is obtained. The second density mathematical formula is used when both luminance uniformity at different viewing angles and high brightness need to fall within a balanced range.

For example, when the included angle x is 60 degrees, the arrangement density y that satisfies the first density mathematical formula is approximately not greater than 64%; the arrangement density y that satisfies the second density mathematical formula is approximately not greater than 29%; and the arrangement density y that satisfies the third density mathematical formula is approximately not greater than 13%.

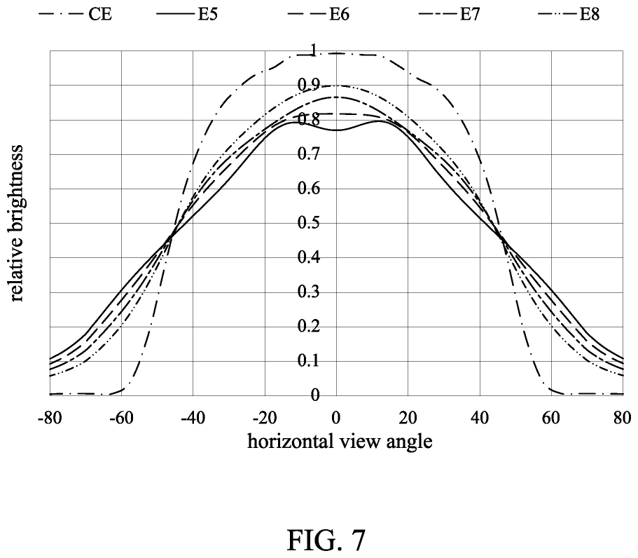

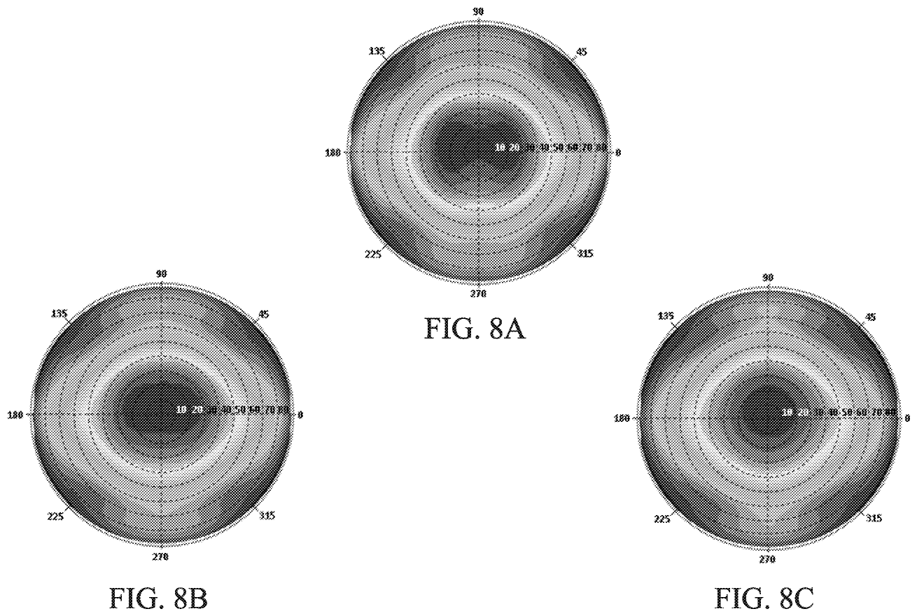

Referring to FIG. 7 and FIG. 8A to FIG. 8C, Embodiment 5 to Embodiment 8 in FIG. 7 are optical film structures with an included angle x of 60 degrees and arrangement densities y of 50%, 40%, 30%, and 20%, respectively, and the comparative example is an optical film that only has prisms that concentrates light to emit in frontal viewing direction but free of the above-mentioned second prisms 104. The relative brightness is the result of luminance normalization at 0 degrees for the comparative example and Embodiment 5 to Embodiment 8, and FIG. 8A to FIG. 8C are schematic diagrams showing the light output intensity for Embodiment 5 to Embodiment 8, respectively. As can be seen from FIG. 7 and FIG. 8A to FIG. 8C, compared to Embodiment 7 (the arrangement density y is close to the curve of the second density mathematical formula) and Embodiment 8 (the arrangement density y falls between the curves of the second density mathematical formula and the third density mathematical formula), Embodiment 5 and Embodiment 6 (the arrangement density y falls between the curves of the first density mathematical formula and the second density mathematical formula) exhibit better luminance uniformity within a range of ±40 degrees, and Embodiment 7 and Embodiment 8 exhibit higher brightness at the front viewing angle (i.e., 0 degrees).

In detail, as shown in FIG. 7, the decline in relative brightness between 0 degrees to ±40 degrees in Embodiment 5 and Embodiment 6 is more gradual than that in Embodiment 7 and Embodiment 8, but the relative brightness at 0 degrees in Embodiment 7 and Embodiment 8 is higher than that in Embodiment 5 and Embodiment 6. In the light output intensity shown in FIG. 8A of Embodiment 5 and FIG. 8B of Embodiment 6, the darkest region with the highest luminance is distributed between 0 degrees to ±30 degrees, and the second-darkest region with the second-highest luminance is distributed between ±30 degrees to ±40 degrees. In the light output intensity shown in FIG. 8C of Embodiment 7, the darkest region with the highest luminance is distributed between 0 degrees to ±20 degrees, and the second-darkest region with the second-highest luminance is distributed between ±20 degrees to ±30 degrees.

Therefore, when the display device requires luminance uniformity, the second prisms 104 of the optical film structure 100 may be designed with an arrangement density y that approximates the curve of the first density mathematical formula; when the display device requires high brightness at front viewing angle, the second prisms 104 of the optical film structure 100 may be designed with an arrangement density y that approximates the curve of the third density mathematical formula; when the display device requires both luminance uniformity and high brightness at front viewing angle, the second prisms 104 of the optical film structure 100 may be designed with an arrangement density y that approximates the curve of the second density mathematical formula.

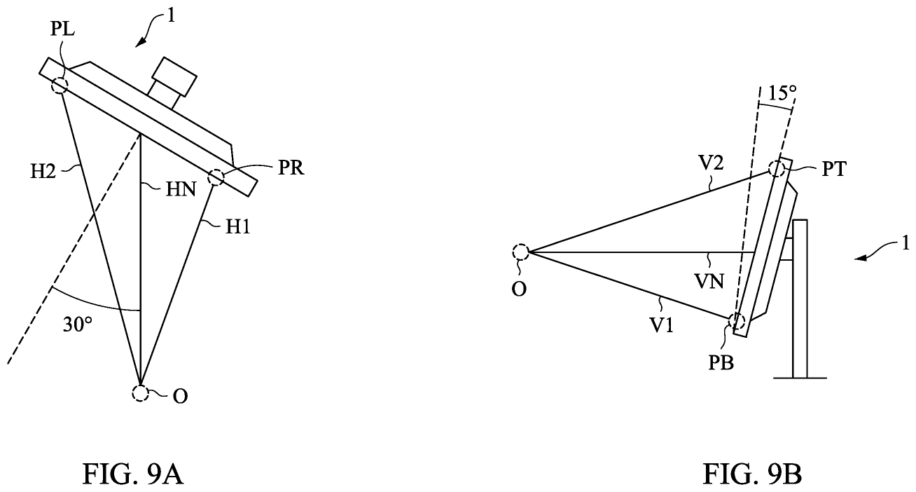

In addition, as shown in FIG. 1, FIG. 9A, and FIG. 9B, an observation position O is defined as a point located at a certain distance in front of the display device 1, and a first side position and a second side position are formed by tilting the display device 1, where the first side position is closer to the observation position O than the second side position. In actual implementation, as shown in FIG. 9A, the first side position refers to one of the left side PL and the right side PR of display device 1, and the second side position refers to the other of the left side PL and the right side PR of the display device 1; as shown in FIG. 9B, the first side position refers to one of the top side PT and the bottom side PB of display device 1, and the second side position refers to the other of the top side PT and the bottom side PB of the display device 1. The left side PL, the right side PR, the top side PT and the bottom side PB are located at a distance of one-tenth of the side length from the edge of the display device 1, and a first side viewing luminance and a second side viewing luminance are formed at the first side position and the second side position, respectively.

Specifically, when light enters the optical film structure 100 from one of the first surface S1 and the second surface S2, and exits from the other of the first surface S1 and the second surface S2, the first side position and the second side position are respectively the right side PR and the left side PL in FIG. 9A, and the first side and the second side are respectively the bottom side PB and the top side PT in FIG. 9B. Therefore, the directions from the observation position O to the right side PR and the left side PL of the display device 1 are defined as the first side viewing direction H1 and the second side viewing direction H2, respectively, or the directions from the observation position O to the bottom side PB and the top side PL of the display device 1 are defined as the first side viewing direction V1 and the second side viewing direction V2, respectively, and the directions from the observation position O to the center of the display device 1 is defined as the frontal viewing directions HN, VN. The frontal viewing direction HN is between the first side viewing direction H1 and the second side viewing direction H2, and the frontal viewing direction VN is between the first side viewing direction V1 and the second side viewing direction V2. The angle between the frontal viewing direction HN, VN and the second side viewing direction H2, V2 is smaller than the angle between the frontal viewing direction HN, VN and the first side viewing direction H1, V1, and the second side viewing luminance<the first side viewing luminance≤1.73 times the second side viewing luminance.

For example, in a 27-inch display device, as shown in FIG. 9A, the display device 1 is horizontally tilted by 30 degrees, where the angle between the first side viewing direction H1 and the frontal viewing direction HN is 40 degrees, and the angle between the second side viewing direction H2 and the frontal viewing direction HN is 17 degrees. As shown in FIG. 9B, the display device 1 is vertically tilted by 15 degrees, where the angle between the first side viewing direction V1 and the frontal viewing direction VN is 22 degrees, and the angle between the second side viewing direction V2 and the frontal viewing direction VN is 7 degrees. When the optical film structure 100 of the present disclosure is used, the arrangement density y and the included angle x of the second prisms 104 of the optical film structure 100 satisfy one of the first density mathematical formula, the second density mathematical formula and the third density mathematical formula, the first side viewing luminance and the second side viewing luminance can conform to the above-mentioned relationship, that is, the second side viewing luminance<the first side viewing luminance≤1.73 times the second side viewing luminance, so as to meet the requirement of 5.10 luminance uniformity—angular dependence in TCO Certified—Generation 9 for displays.

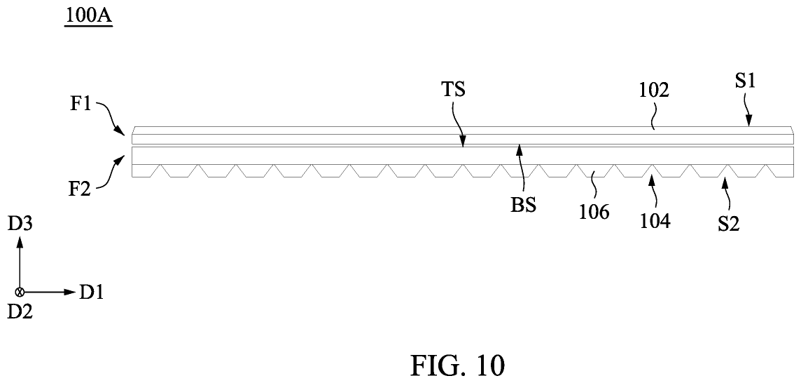

Referring to FIG. 10, the structures and the designs of most elements in the embodiment of FIG. 10 and the embodiment of FIG. 1 are the same, so the same features are not repeated here. The difference between the two embodiments is that the optical film structure 100A in FIG. 10 includes a first film sheet F1 and a second film sheet F2. The first film sheet F1 has a first surface S1 and a bottom surface BS opposite to the first surface S1, and multiple first prisms 102 are located at the first surface S1 of the first film sheet F1. The second film sheet F2 has a second surface S2 and a top surface TS opposite to the second surface S2, and multiple second prisms 104 are located at the second surface S2 of the second film sheet F2, where the top surface TS is between the second surface S2 and the bottom surface BS. In some embodiments, microstructures may be formed on the bottom surface BS of the first film sheet F1 and/or the top surface TS of the second film sheet F2, which may reduce the moire pattern of the first prisms 102 and/or the second prisms 104 and thus improve display quality.

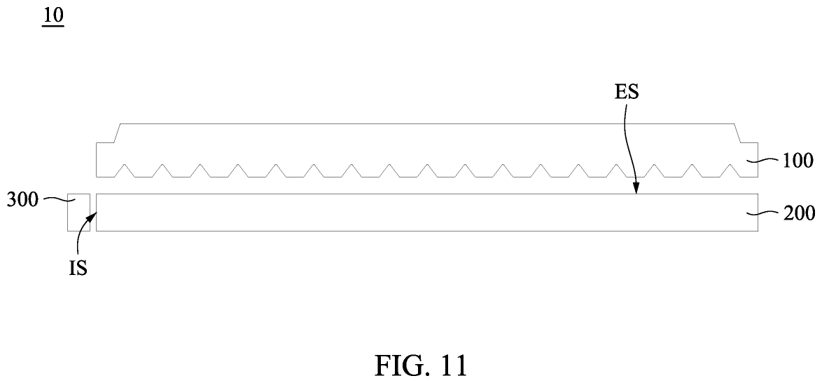

Referring to FIG. 11, a backlight module 10 includes a light guide plate 200, a light source 300, and the optical film structure 100. The light guide plate 200 has a light-incident surface IS and a light-emitting surface ES. The light source 300 is disposed at the light incident surface IS, and the optical film structure 100 is disposed in front of the light-emitting surface ES. In other embodiments, the optical film structure of the backlight module 10 may be the optical film structure 100A of FIG. 10.

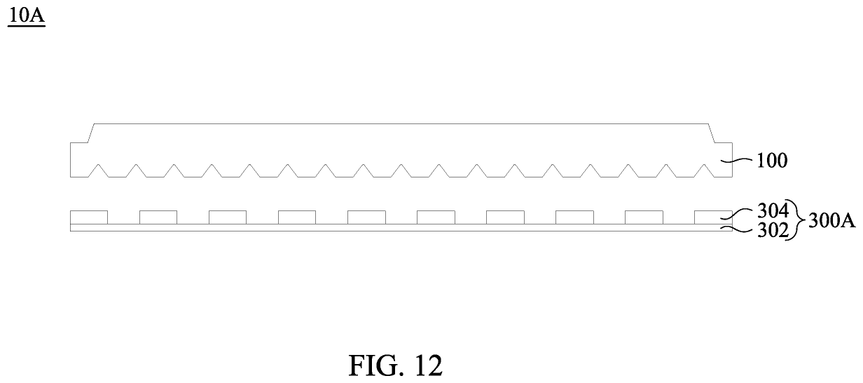

Referring to FIG. 12, a backlight module 10A includes a light source 300A and the optical film structure 100. The light source 300A includes a substrate 302 and multiple light-emitting units 304 arranged on the substrate 302, and the optical film structure 100 is disposed in front of the light source 300A. In other embodiments, the optical film structure of the backlight module 10A may be the optical film structure 100A of FIG. 10.

In some embodiments, the optical film structures 100, 100A are mainly located between the diffuser and the dual brightness enhancement film (DBEF) to replace conventional prism sheets, thereby solving the problem that conventional prism sheets use high refractive index materials to increase brightness but cause a reduction in viewing angles.

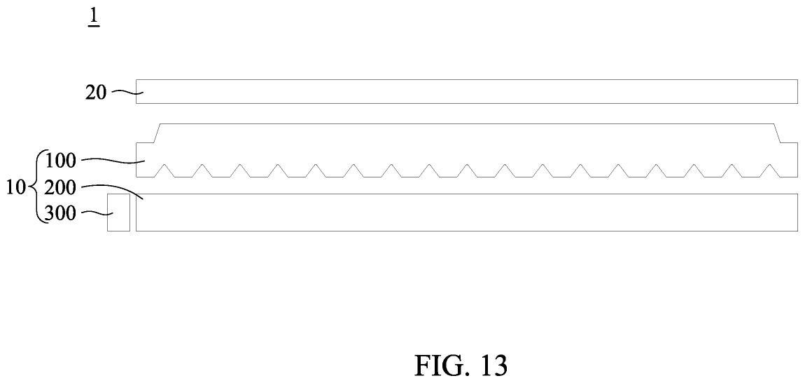

Referring to FIG. 13, a display device 1 includes the backlight module 10 and a display panel 20. The display panel 20 is disposed in front of the backlight module 10, and the display panel 20 may be a liquid crystal display panel. In other embodiments, the backlight module of the display device 1 may be the backlight module 10A of FIG. 12.

In summary, in the optical film structure, the backlight module including the aforementioned optical film structure, and the display device including the aforementioned backlight module of at least one embodiment of the present disclosure, by ensuring that the arrangement density and the included angle of the prisms of the optical film structure satisfy the first density mathematical formula: 0<y≤−0.00000543x³+0.00193x²−0.20997x+7.46116, the luminance uniformity at different viewing angles of the display device can be improved. The present disclosure utilizes the design of the second prisms to adjust the included angle and the arrangement density, thereby precisely controlling the light emits at different dimensions and achieving excellent performance in terms of high brightness or high contrast. Moreover, the viewing angle in the horizontal or vertical direction can be freely adjusted according to different application needs, providing a better user experience. Furthermore, applying the optical film structure of the present disclosure to backlight modules and display devices not only meets the requirement of 5.10 luminance uniformity—angular dependence in TCO Certified—Generation 9 for displays, but also effectively improves the optical efficiency of display devices, reduces energy consumption, complies with the stringent requirements of international organizations such as the EU for energy conservation and carbon reduction in electronic products, and addresses the urgent need for high-contrast gaming monitors in recent years. It also offers multiple advantages, including simplified manufacturing processes, reduced costs, and compliance with environmental trends.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. An optical film structure, having a first surface and a second surface opposite to the first surface, and comprising:
a plurality of first prisms, located at the first surface, wherein each of the first prisms extends in a first direction; and
a plurality of second prisms, located at the second surface, wherein each of the second prisms extends in a second direction different from the first direction, and the second prisms have an arrangement density y, wherein each of the second prism has a first inclined surface and a second inclined surface connected to each other, and an included angle x is formed between the first inclined surface and the second inclined surface, wherein the arrangement density y and the included angle x satisfy a first density mathematical formula: 0<y≤−0.00000543x³+0.00193x²−0.20997x+7.46116.

2. The optical film structure of claim 1, wherein an interval exists between any adjacent two of the second prisms, and the arrangement density y is calculated by a function, wherein the function is
$$y = \frac{( P - W )}{P} ,$$
wherein P is a pitch between any adjacent two of the second prisms, and W is a width of each of the intervals.

3. The optical film structure of claim 1, wherein each of the second prisms comprises a strip-shaped groove or a strip-shaped rib.

4. The optical film structure of claim 1, wherein the first direction is perpendicular to the second direction.

5. The optical film structure of claim 1, wherein the arrangement density y and the included angle x further satisfy a second density mathematical formula: 0<y≤0.0002x²−0.0318x+1.4829.

6. The optical film structure of claim 1, wherein the arrangement density y and the included angle x further satisfy a third density mathematical formula: 0<y≤0.00000277x³−0.000654x²+0.05165x−1.21674.

7. The optical film structure of claim 1, comprising:
a first film sheet, having the first surface and a bottom surface opposite to the first surface, wherein the first prisms are located at the first surface of the first film sheet; and
a second film sheet, having the second surface and a top surface opposite to the second surface, wherein the second prisms are located at the second surface of the second film sheet, and the top surface is between the second surface and the bottom surface.

8. A backlight module, comprising:
a light guide plate, having a light-incident surface and a light-emitting surface;
a light source, disposed at the light-incident surface; and
the optical film structure of claim 1, disposed in front of the light-emitting surface.

9. A display device, comprising:
the backlight module of claim 8; and
a display panel, disposed in front of the backlight module.

10. The display device of claim 9, wherein an observation position is defined at a certain distance in front of the display device, and a first side position and a second side position are formed by tilting the display device, wherein the first side position is closer to the observation position than the second side position, and a first side viewing luminance and a second side viewing luminance are formed at the first side position and the second side position, respectively, wherein a first side viewing direction is from the observation position to the first side position and a second side viewing direction is from the observation position to the second side position, and a frontal viewing direction is from the observation position to a center of the display device, wherein the frontal viewing direction is between the first side viewing direction and the second side viewing direction, and an angle between the frontal viewing direction and the second side viewing direction is smaller than an angle between the frontal viewing direction and the first side viewing direction, wherein the second side viewing luminance<the first side viewing luminance≤1.73 times the second side viewing luminance.

11. A backlight module, comprising:
a light source, comprising a substrate and a plurality of light-emitting units arranged on the substrate; and
the optical film structure of claim 1, disposed in front of the light source.

12. A display device, comprising:
the backlight module of claim 11; and
a display panel, disposed in front of the backlight module.

13. The display device of claim 12, wherein an observation position is defined at a certain distance in front of the display device, and a first side position and a second side position are formed by tilting the display device, wherein the first side position is closer to the observation position than the second side position, and a first side viewing luminance and a second side viewing luminance are formed at the first side position and the second side position, respectively, wherein a first side viewing direction is from the observation position to the first side position and a second side viewing direction is from the observation position to the second side position, and a frontal viewing direction is from the observation position to a center of the display device, wherein the frontal viewing direction is between the first side viewing direction and the second side viewing direction, and an angle between the frontal viewing direction and the second side viewing direction is smaller than an angle between the frontal viewing direction and the first side viewing direction, wherein the second side viewing luminance<the first side viewing luminance≤1.73 times the second side viewing luminance.
